(19) United States
(12) Patent Application Publication
(10) Pub. No.: US 2026/0199868 A1
(43) Pub. Date: Jul. 16, 2026

(54) METAL OXIDE FUNCTIONALIZED NANO POROUS CARBON-DERIVED SORBENTS FOR LOW-CONCENTRATION CO2 CAPTURE APPLICATIONS

(71) Applicant: Battelle Memorial Institute, Columbus, OH (US)

(72) Inventors: Ping Wang, Venetia, PA (US); David Hopkinson, Morgantown, WV (US); Ali K. Sekizkardes, Mcdonald, PA (US); Patrick Muldoon, Elizabeth, PA (US); Nicholas Means, Pittsburgh, PA (US)

(21) Appl. No.: 19/134,688

(22) PCT Filed: Dec. 1, 2023
(86) PCT No.: PCT/US2023/082173

§ 371 Date: May 30, 2025

Related U.S. Application Data
(60) Provisional application No. 63/429,493, filed on Dec. 1, 2022.

(51) Int. Cl. B01J 20/20; B01D 53/04; B01D 53/047; B01J 20/04; B01J 20/30; B01J 20/32; C01B 32/348

(52) U.S. Cl. CPC B01J 20/20; B01D 53/0462; B01D 53/047; B01J 20/041; B01J 20/3071; B01J 20/3078; B01J 20/3204; B01J 20/3221; B01J 20/3236; C01B 32/348; B01D 2253/102; B01D 2253/1124; B01D 2257/504

(57) ABSTRACT

A sorbent is made by pyrolyzing a carbon source (preferably coal) at a temperature of at least 500° C. to form pyrolyzed porous carbon that is reacted with acid to form carboxylic acid (—COOH) moieties and adding a metal ion to bind the metal at the carboxylate sites in the pyrolyzed porous carbon. A sorbent is described that comprises a pyrolyzed porous carbon support; magnesium and carboxylate moieties disposed in the pyrolyzed porous carbon support; and possessing a CO2 adsorption isotherm between 0.0 and 0.05 bar CO₂ having a slope that is at least 20% greater than between 0.40 and 0.45. CO₂ can be selectively removed via pressure and/or temperature swing desorption by contacting a CO₂-comprising fluid with the sorbent.

### RELATED APPLICATIONS

This application claims priority to U.S. Provisional Patent Application Ser. No. 63/429,493 filed 1 Dec. 2022.

### GOVERNMENT RIGHTS CLAUSE

This invention was made with Government support from U.S. Department of Energy, National Energy Technology Laboratory including contract RSS contract 89243318CFE000003. The Government has certain rights in this invention.

### BACKGROUND

Removal of CO₂ and other pollutants from the environment is an area of intensive concern and importance. Therefore, a large amount of work has been expended to develop sorbents to ameliorate these problems. For example, Graham et al. in U.S. Pat. No. 6,858,192 describes absorbents for removing odors made by preoxidizing a carbon material such as by exposure to steam or phosphoric acid, grinding the preoxidized carbon material; and mixing the ground preoxidized material with a metal oxide. Liu et al. in US 2014/0117283 A1 describes a sorbent that includes activated carbon impregnated with magnesium oxide, wherein the magnesium oxide constitutes at least 5% by weight of the sorbent. Shahkarami et al. in “Enhanced CO2 Adsorption Using MgO-Impregnated Activated Carbon: Impact of Preparation Techniques”, Industrial & Engineering Chemistry Research, (2016) 55 (20), 5955-5964 describe a sorbent made from biochar impregnated with magnesium salt solutions followed by steam activation. Similarly, Guanghui et al., in “Fabrication of MgO@ AC porous composite for CO2 capture by a solid-state heat dispersion approach”, Journal of Porous Materials 2020, 27 (4), 1051-1058 describe a sorbent prepared by treating activated carbon with Mg(NO3)2. A small sampling of other publications describing sorbents include: Qiuyun Pu, et al., “Biomass-derived carbon/MgO—Al2O3 composite with superior dynamic CO2 uptake for post combustion capture application”, Journal of CO2 Utilization 2021, 54, 101756; Li, Y., et al. “Highly microporous nitrogen-doped carbons from anthracite for effective CO2 capture and CO2/CH4 separation”, Energy, (2020).211, 118561; Czyżewski, A. et al., “On competitive uptake of SO2 and CO2 from air by porous carbon containing CaO and MgO”, Chemical Engineering Journal, (2013).226, 348-356; “Synthetic solid oxide sorbents for CO2 capture: state-of-the art and future perspectives” Chang, X. Wu, O. Cheung and W. Liu, J. Mater. Chem. A, 2022, 10, 1682-1705; “Efficient CO2 capture from ambient air with amine functionalized Mg—Al mixed metal oxides” X. Zhu, T. Ge, F. Yang, M. Lyu, C. Chen, D. O'Hare and R. Wang, J. Mater. Chem. A, 2020, 8, 16421-16428; Li, Chen, Lin and Li, Chemical Engineering Journal, 2021, 404, 126459; Li, X. D. Sun, X. Y. M. Dong, Y. Wang and J. H. Zhu, ChemNanoMat, 2017, 3, 822-832; A. Hanif, S. Dasgupta and A. Nanoti, Ind. Eng. Chem. Res., 2016, 55, 8070-8078; S. J. Han, Y. Bang, H. J. Kwon, H. C. Lee, V. Hiremath, I. K. Song and J. G. Seo, Chemical Engineering Journal, 2014, 242, 357-363; Li, W. Liu, J. S. Dennis and H. C. Zeng, ACS Appl. Mater. Interfaces, 2017, 9, 9592-9602; G.-B. Elvira, G.-C. Francisco, S.-M. Víctor and M.-L. R. Alberto, Journal of Environmental Sciences, 2017, 57, 418-428; T. K. Kim, K. J. Lee, J. Y. Cheon, J. H. Lee, S. H. Joo and H. R. Moon, J. Am. Chem. Soc., 2013, 135, 8940-8946; W.-J. Liu, H. Jiang, K. Tian, Y.-W. Ding and H.-Q. Yu, Environ. Sci. Technol., 2013, 47, 9397-9403; Li, M. M. Wan, X. D. Sun, J. Zhou, Y. Wang and J. H. Zhu, J. Mater. Chem. A, 2015, 3, 18535-18545; Bhagiyalakshmi, P. Hemalatha, M. Ganesh, P. M. Mei and H. T. Jang, Fuel, 2011, 90, 1662-1667; U.S. Pat. Nos. 5,021,164; 6,589,904; 9,776,165; 10,744,485; 10,950,849; and 9,005,816.

### SUMMARY OF THE INVENTION

This invention provides a CO₂ sorbent that combines the desirable properties of a high porosity carbon with a highly dispersed metal oxide functionality (high capacity for CO₂). By using the specific synthesis and functionalization method described herein, this low-cost sorbent becomes particularly effective for absorption of CO₂ from low concentration sources such as ambient air at ambient temperature and pressure, more so than other reported materials.

The synthesis of the metal oxide functionalized coal-derived sorbent entails a three-step sorbent preparation method such as shown in FIG. 1. The first step is the use of subbituminous coal and conversion to highly porous (activated) carbon sorbent (NPC). The NPC was pyrolyzed under basic conditions to create the microporosity and high surface area in the sorbent media. In the second step, the sorbent is post-synthetically oxidized by acid groups (—COOH) to afford NPC-acid. In the third step, Mg⁺² ions were introduced to be tethered to the acid functional groups and ultimately form MgO moieties in a highly porous sorbent scaffold (NPC-MgO). The preparation method can be easily applied to different types of acids such as sulfonic acid and to different metals such as Li depending on the application. It can also be used to any other porous carbon source like biomass.

In one aspect, the invention provides a method of making a sorbent, comprising: pyrolyzing a carbon source (preferably coal) at a temperature of at least 500° C. to form pyrolyzed porous carbon; subsequently, reacting the pyrolyzed porous carbon with acid to form carboxylic acid (—COOH) moieties in the pyrolyzed porous carbon; and adding a metal source and contacting the metal source with the carboxylic acid moieties to bind the metal at the carboxylate sites in the pyrolyzed porous carbon. Because of the amorphous nature of the sorbent, it is necessary to characterize the sorbent by its properties.

The method can be further characterized by one or any combination of the following: wherein the step of pyrolyzing is conducted in the absence of dioxygen (O₂); wherein the step of pyrolyzing is conducted at a temperature of at least 600° C.; wherein the step of pyrolyzing is conducted at a temperature in the range of 500 to 800° C.; wherein, prior to the step of pyrolyzing, the carbon source is treated with a base; wherein the base comprises an aqueous solution comprises hydroxyl groups and wherein the hydroxyl groups are added in a molar amount greater than the moles of carbon in the carbon source; wherein the carbon source is coal; wherein, after the step of pyrolyzing, the pyrolyzed carbon is washed with an aqueous acid solution, optionally followed by washing with acetone; wherein an aqueous slurry of the pryolyzed carbon is treated with nitric acid; wherein the nitric acid is added in an amount of 0.5 to 10 wt % in relation to the pyrolyzed carbon, or 0.5 to 5 wt % or 1 to 3 wt % as compared to the pyrolyzed carbon; wherein the pyrolyzed carbon that has been treated with nitric acid is separated and washed with water and, optionally, washed with acetone; wherein the step of reacting the pyrolyzed porous carbon with acid is conducted at a temperature of at least 70° C., at least 80° C., or in the range of 80 to 105° C.; wherein the pyrolyzed carbon that has been treated with acid is treated with a metal-containing solution; wherein the metal-containing solution comprises an aqueous Mg solution; wherein moles of metal atoms in the metal-containing solution exceeds the moles of COOH moieties; wherein the pyrolyzed porous carbon with carboxylic acid moieties that has been contacted with the metal source is subsequently heated to at least 150° C. or heated in the range of 200 to 500° C. or in the range of 300 to 400° C.

The invention also includes a sorbent made by the any of the methods described herein.

In another aspect, the invention provides a sorbent, comprising: a pyrolyzed porous carbon support; magnesium and carboxylate moieties disposed in the pyrolyzed porous carbon support; and characterizable by (possessing): a CO₂ adsorption isotherm between 0.0 and 0.05 bar CO₂ having a slope that is at least 20% greater than between 0.40 and 0.45 bar CO₂; or a CO₂ adsorption isotherm between 0.0 and 0.1 bar CO₂ having a slope that is at least 20% greater than between 0.40 and 0.50 bar CO₂.

The sorbent can be further characterized by one or any combination of the following: a CO₂ adsorption isotherm between 0.0 and 0.05 bar CO₂ having a slope that is at least 40% greater than between 0.40 and 0.45 bar CO₂; a CO₂ adsorption isotherm between 0.0 and 0.1 bar CO₂ having a slope that is at least 40% greater than between 0.40 and 0.50 bar CO₂; an infrared absorption peak centered at about 1600 cm⁻¹ having an integrated intensity at least 20 times than the hydroxyl peak at about 1710 cm⁻¹; an infrared absorption peak centered at about 1600 cm⁻¹ having an integrated intensity at least 20 times than the hydroxyl peak at about 1710 cm⁻¹.

The invention also provides a method of removing CO₂ comprising contacting the sorbent with a CO₂-comprising fluid. The CO₂ can be removed via pressure and/or temperature swing desorption. Preferably, the sorbent maintains at least 95% of its CO₂ sorption capacity after 5 cycles of pressure and/or temperature swing desorption.

The invention can be applied to direct air capture of CO₂. The invention also includes methods of using the sorbent for CO₂ capture from natural gas or coal fired power plants; natural gas purification; removal of CO₂ from industrial point sources including steel, cement and production plants, etc.; rare earth elements capture; precious and toxic metal capture; membrane-based gas and liquid separation; gas storage; solid state energy storage; and gas sensor applications.

The invention also includes any combination or subset of the method steps described herein. The invention further includes a system that comprises the components described in the methods.

The invention may be further characterized by any of the data presented here. For example, any of the inventive aspects can be described as possessing one or any combination of the properties and/or compositions (or within ±10%, ±20%, or ±30% of one or any combination of the properties and/or compositions) described herein. All ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of”. As used in this specification, the terms “include”, “includes” or “including” should not be read as limiting the invention but, rather, listing exemplary components.

### BRIEF DESCRIPTION OF THE DRAWINGS

FIG. 1. Representative preparation scheme of the invented sorbent. Me stands for metal.

FIG. 2. FTIR spectra of NPC (top), NPC-acid (middle) and NPC-MgO (bottom).

FIG. 3. Nitrogen adsorption and desorption isotherm (77 K) of NPC (top), NPC-acid (middle) and NPC-MgO (bottom). The filled circles are adsorption points, and the empty circles are desorption points.

FIG. 4. CO₂ adsorption and desorption isotherm (298K) of NPC (middle at 1.0 bar), NPC-acid (top at 1.0 bar) and NPC-MgO (bottom at 1.0 bar).

FIG. 5. CO₂ adsorption (at 298K) and desorption (at 423K under vacuum) cycles of NPC-MgO.

FIG. 6. CO₂ and N₂ adsorption isotherm (at 298K) of NPC-MgO.

FIG. 7. Initial slopes of CO₂ (grey) and N₂ (blue) isotherms of NPC-acid and NPC-MgO used in CO₂/N₂ selectivity calculations.

FIG. 8: Virial analysis of CO₂ adsorption isotherms (circles: 298 K, squares: 313 K) used to calculate isosteric heats of adsorption (Qₛₜ) by the Clausius-Clapeyron equation for CO₂ of NPC-acid (top) and NPC-MgO (bottom).

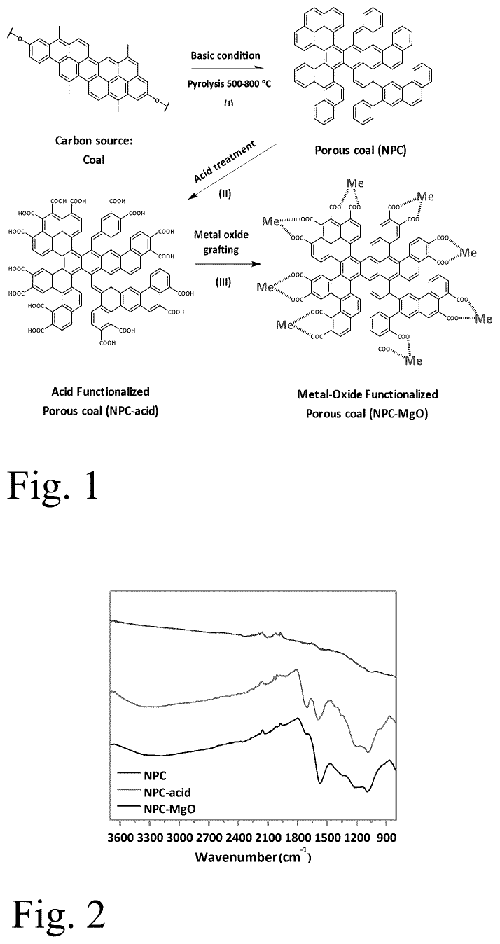

### DETAILED DESCRIPTION OF THE INVENTION

A preferred source of carbon is coal (bituminous, sub bituminous, and/or lignite); however, the invention can be applied to other types of porous carbon or activated carbon resources such biomass (such as lignocellulosic biomass (wood, grasses, agricultural residues, etc.), waste plastics, etc. The source of carbon preferably comprises at least 50, at least 60, at least 70, at least 80, or at least 90 mass % C; and preferably comprises 40 or less, 30 or less, 20 or less, 10 or less, 5 or less mass % O. The carbon that is pyrolyzed may have a mass average size of 500 μm or less, and optionally may be comminuted prior to pyrolysis. Preferably, the C/O atomic ratio in the carbon source is at least 2/1 or at least 4/1.

The pyrolyzed carbon is preferably impregnated with Mg, but other metals such as other alkaline earth elements, or transition metals such as Fe or Cu can be used in place of, or mixed with Mg. Desirably, the metal is a soluble salt such as MgCl₂.

As used herein, the terms “pyrolysis” and “pyrolyzing” are given their conventional meaning in the art and are used to refer to the transformation of a carbon-containing substance, preferably coal, or a solid hydrocarbonaceous material, into a pyrolyzed porous carbon, by heat, preferably without the addition of, or in the absence of, O₂. Preferably, the volume fraction of O₂ present in a pyrolysis reaction chamber is 0.5% or less; preferably the atomic ratio of C/O (accounting for all mass in a pyrolysis reaction chamber) is at least 20, or at least 50, or at least 100.

The sorbent can be used in a process (typically temperature and/or pressure swing adsorption) for removal of CO₂ from a CO₂-comprising fluid. The CO₂-comprising fluid could be a concentrated fluid such as a gaseous fluid comprising at least 5% (by volume CO₂). Alternatively, the fluid may contain between 0.0001 and 0.50 bar, or between 0.01 and 0.50 bar, or between 0.1 and 0.50 bar, or between 0.01 and 0.05 bar. Preferably, the CO₂-comprising fluid is air.

The invention was experimentally proven and characterized by common instrumentation including surface area analyzer, FT-IR and TGA. Porous coal (NPC) showed a characteristic FTIR spectrum without a significant peak indicating prominent functional groups in the material (FIG. 2). Acid-functionalized porous coal (NPC-acid) on the other hand revealed the IR absorption band at 1710 cm¹ demonstrating the successful oxidation of the coal and the new carbonyl functional groups along with other IR absorption peaks at 3500 cm⁻¹ (—OH) 1580 cm⁻¹ (C═C) and 1200 cm⁻¹ (C—O). The strong carbonyl peak was found to be greatly depleted by incorporation of Mg into the sorbent (NPC-MgO). The diminished IR peaks at 1710 and 1350 cm⁻¹ which represent carboxylic acid functionalities can be attributed to the interaction between the carbonyl of carboxylic acid groups of the coal with the guest Mg⁺² ions.

Thermogravimetric analysis (TGA) was used to characterize the thermal stability of the sorbent. NPC-acid had a 10 wt % loss between 200-400° C. which can be attributed to the decomposition of acid groups. NPC-MgO showed more thermal stability and relatively smaller weight loss (2 wt %), which can be attributed to the increased thermal stability resulting from Mg replacing the acidic hydrogen of NPC-acid.

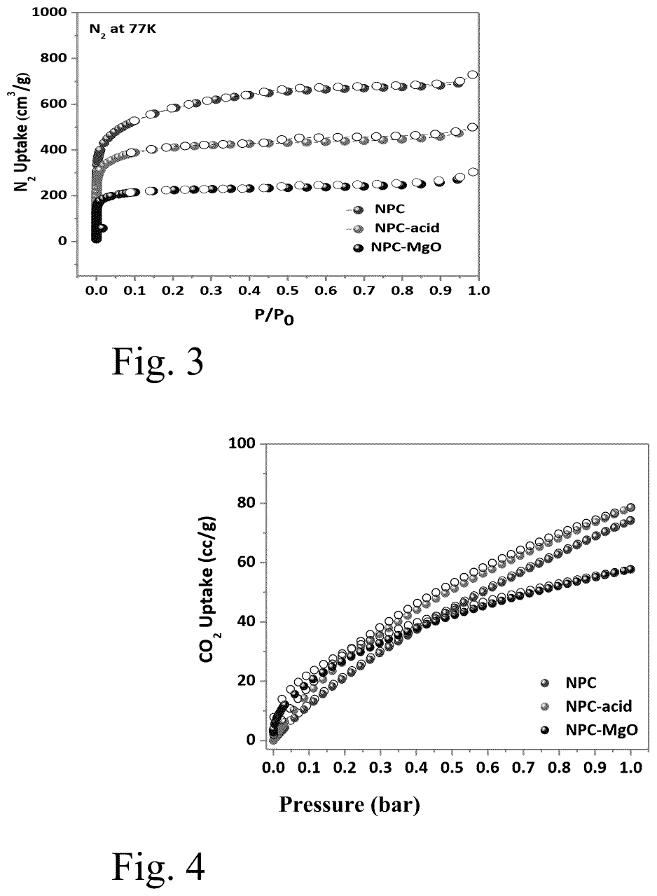

Porosity measurements were collected by fitting N₂ isotherms (at 77K) for all samples (FIG. 3). NPC showed a high Brunauer-Emmett-Teller (BET) surface area (2130 m²/g) with high microporosity which was calculated by non-local density functional theory (NLDFT). The high porosity was instrumental in the porous coal before the functionalization steps in order to maximize the available sites for functional groups. After functionalization, the porosity is reduced. Acid functionalized porous coal, NPC-acid, showed a drop in the surface area (1470 m²/g) for coal-acid which was expected considering the creation of new functional groups in the pores. The pyrolyzed carbon preferably has a porosity of at least 1500 or at least 2000 m²/g, typically up to 2500 or 2200 m²/g. The sorbent preferably has a porosity of at least 1000 or at least 1200 m²/g, typically up to 1700 or 1500 m²/g.

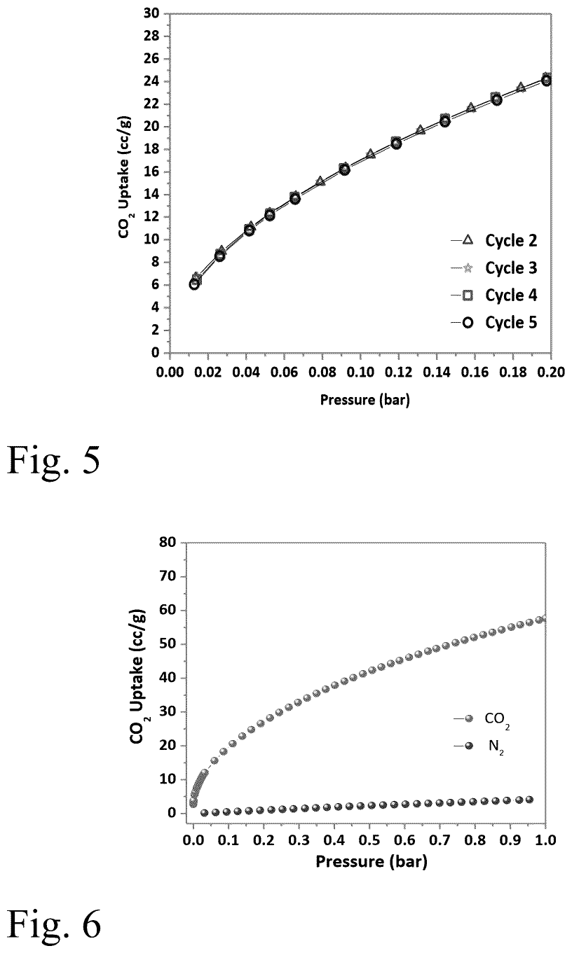

The invented sorbent was tested with commercial gas adsorption analyzers. CO₂ adsorption capacity (at low partial pressure) of NPC-MgO sorbent was found to be drastically higher than the neat and acid functionalized carbon, NPC and NPC-acid, respectively (see FIG. 4). The CO₂ uptake was two magnitudes of order higher at 400 ppm CO₂ compared to NPC-acid. Several following CO₂ adsorption and desorption cycles showed that the CO₂ uptake performance remains consistent over the cycles (see FIG. 5). This drastically improved CO₂ uptake can be attributed to three factors: (i) CO₂ attractive MgO functional group in the sorbent, (ii) high surface area and (iii) good dispersion of MgO throughout the porous sorbents. Low concentration CO₂ capture applications such as Direct Air Capture operate in ambient conditions (400 ppm CO₂) where dense or even porous metal oxide sorbents perform poorly. Although the high microporosity in NPC benefits CO₂ attraction to the sorbent, the pores also need to be functionalized by polar groups to attract more CO₂ from the low concentration streams. The acid-functionalized porous coal, NPC-acid, exhibited higher CO₂ uptake capacity in comparison to the low-pressure region compared to NPC. The polar carboxylic acid functionalities coupled with the high porosity of the coal led to the improvement in the CO₂ uptake performance in the low-pressure region.

It is believed that acid groups are used not to capture CO₂ but rather to tether guest Mg⁺² ions and ultimately create Mg oxide (MgO) groups in the sorbent. By contrast, other MgO-based porous or dense sorbents suffer from a high energy cost due to the transport of CO₂ molecules in and out of the sorbent. However, their operating temperature is relatively lower (<500° C.) compared to other metal oxides such as CaO. Therefore, we have selected Mg as the metal of choice in the third step. Another major drawback of porous carbons is the low CO₂/N₂ selectivity. CO₂/N₂ selectivity of NPC-MgO was calculated by the initial slope method (FIG. 6). The selectivity of NPC-MgO was calculated as 154 at 298K which outperforms the selectivity (41) of NPC-acid and competes with the best performing functionalized porous carbon reported to date. We have calculated the isosteric heats of adsorption (Qst) for CO₂ by fitting the CO₂ isotherms collected at different temperatures. Qst of NPC-MgO was calculated as 49.4 kJ/mol which is higher than NPC-acid (23.2 kJ/mol) and can be classified as chemical sorption. The hysteresis between the adsorption and desorption isotherms of NPC-MgO also confirms the chemisorption behavior of the sorbent.

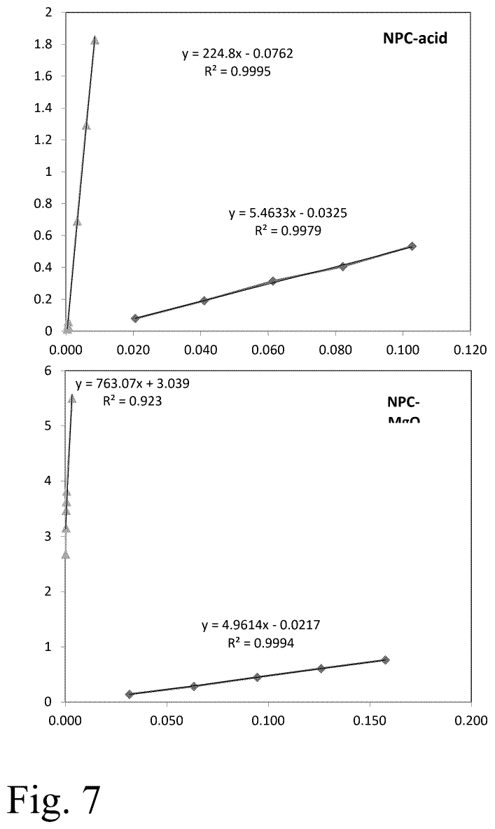

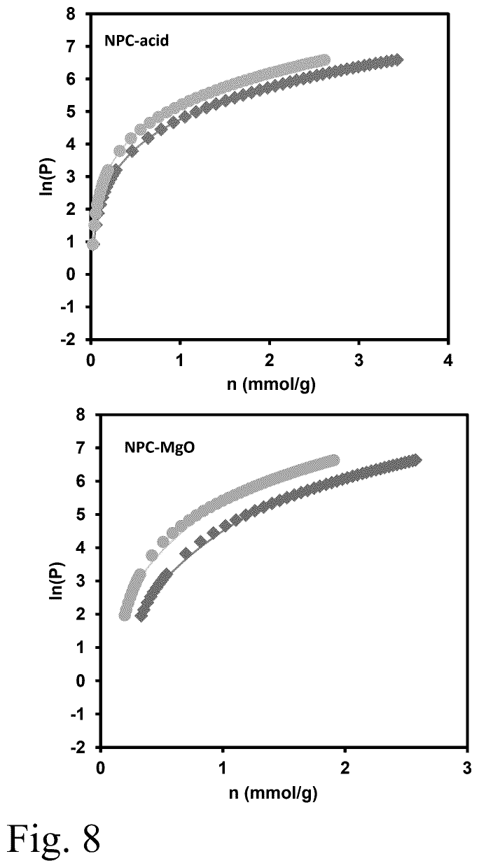

The change in CO₂/N₂ selectivity after MgO functionalization was also evaluated, as one of the major drawbacks of porous carbon is low CO₂/N₂ selectivity. Remarkably CO₂/N₂ selectivity, calculated by the initial slope method (FIGS. 6 and 7), of NPC-MgO was found to be 154 at 298 K which is nearly four-fold that of NPC-acid (41). The CO₂ adsorption performance of NPC-MgO at a low partial pressure of CO₂ (0.004-10%) compares favourably with reported CO₂ uptake of Mg oxide functionalized porous carbons as well as porous and nonporous metal oxides (Table 1). The isosteric heats of adsorption (Qst) were calculated for CO₂ by fitting the CO₂ adsorption isotherms collected at different temperatures (FIG. 8). Qst of NPC-MgO was 49.4 kJ/mol which is higher than NPC-acid (23.2 kJ/mol) and can be classified as chemical sorption. The hysteresis between the adsorption and desorption isotherms of NPC-MgO is also indicative of chemisorption behavior.

This study has demonstrated that inexpensive commodities such as coal and metal oxides can be effectively converted into high performance CO₂ adsorbents. The metal oxide functionalized porous carbon (NPC-MgO) overcomes the limitations that exist with both porous carbon and metal oxides in low-concentration CO₂ capture applications. The effective use of the high surface area, pore size, and acid functionalization of porous carbon provides an ideal media for Mg oxides to be strongly and homogeneously bound to the sorbent without detectable metal aggregation. This resulted in an over 300-fold improvement in CO₂ capacity at 400 ppm (0.12 mmol/g) and substantially higher CO₂/N₂ selectivity (154 at 298 K) compared to the oxidized porous carbon (CO₂ uptake (400 ppm): 0.002 mmol/g and CO₂/N₂ selectivity. Properties of this unique sorbent design can be altered by utilizing other porous carbon and metal oxide combinations.

### Synthesis Materials, Methods, and Preparations

All chemicals were purchased from Sigma Aldrich and were used without any further purification.

### Synthesis of Nano Porous Carbon (NPC)

Nanoporous carbon (NPC) preparation includes chemical activation by impregnation and a pyrolysis/activation process. Powder River Basin (PRB) subbituminous coal with a particle size of 106-180 μm was used as precursor for NPC. The proximate and ultimate analysis of the coal is listed in Table 1. The coal was activated using KOH at a ratio of 1:2 by weight and those were mixed by stirring with deionized water for 3 h at 65° C. The resultant slurry was dried in a 110° C. oven. In the pyrolysis/activation process, the resulting sample was heated in a fixed bed reactor using a 316 stainless steel boat under N₂ at 100 mL/min. Heating was done at 10° C./min to 800° C. and held for 1 hr. After that, the sample was washed with hydrochloric acid (HCl) solution to remove impurities followed by washing with deionized water until the pH of the rinsed water reached ~7. Finally, the washed carbon sample was further washed with acetone and dried in a 130° C. oven to result in NPC.

TABLE 1
Proximate and ultimate analysis of the Powder River basin (PRB) sub-bituminous coal

| | Proximate analysis (% dry basis) | | | Ultimate analysis (% dry basis) | | | | |
|---|---|---|---|---|---|---|---|---|
| | Fixed | Volatile | | | | | | O |
| Sample | carbon | matter | Ash | C | H | N | S | (diff.) |
| PRB | 65.44 | 45.08 | 7.26 | 65.4 | 4.39 | 0.72 | 0.48 | 21.71 |
| Coal | | | | | | | | |

### Synthesis of Acid Functionalized Porous Carbon (NPC-Acid)

200 mg of NPC, 15 mL DI water, and a stir bar were combined in a 50 mL round bottom flask. 5 mL of concentrated HNO₃ was added, carefully. The flask was secured in an oil bath with a condenser (no water) topped with a vacuum adapter. The reaction mixture was stirred at 400 rpm and heated to 100° C. for 24 hours after which the reaction was cooled to room 5 temperature, transferred to a fritted glass filtration funnel and washed with 200 mL of DI water. The solid black powder was left in ~50 mL of water for one day, and then washed with acetone (200 mL). The material was then dried in a 130° C. oven overnight.

### Synthesis of the MgO Functionalized Porous Carbon (NPC-MgO)

125 mg of NPC-acid was dispersed in 7 mL of 1 M Mg(NO₃)₂·6H₂O and dimethylformamide (DMF) and heated to 85° C. while stirring for 1 day. The sample was filtered from the solution and washed with DMF (4×20 mL) followed by acetone (4×20 mL). The powder was then dried in a 130° C. oven for 1 day. The final product was activated at 350° C. under vacuum prior to characterization.

1. A method of making a sorbent, comprising:
pyrolyzing a carbon source (preferably coal) at a temperature of at least 500° C. to form pyrolyzed porous carbon;
subsequently, reacting the pyrolyzed porous carbon with acid to form carboxylic acid (—COOH) moieties in the pyrolyzed porous carbon; and
adding a metal source and contacting the metal source with the carboxylic acid moieties to bind the metal at the carboxylate sites in the pyrolyzed porous carbon.

2. The method of claim 1 wherein the step of pyrolyzing is conducted in the absence of dioxygen (O₂).

3. The method of claim 1 wherein the step of pyrolyzing is conducted at a temperature of at least 600° C.

4. The method of claim 1 wherein the step of pyrolyzing is conducted at a temperature in the range of 500 to 800° C.

5. The method of claim 1 wherein, prior to the step of pyrolyzing, the carbon source is treated with a base.

6. The method of claim 5 wherein the base comprises an aqueous solution comprises hydroxyl groups and wherein the hydroxyl groups are added in a molar amount greater than the moles of carbon in the carbon source.

7. The method of claim 1 wherein the carbon source is coal.

8. The method of claim 1 wherein, after the step of pyrolyzing, the pyrolyzed carbon is washed with an aqueous acid solution, optionally followed by washing with acetone.

9. The method of claim 1 wherein an aqueous slurry of the pryolyzed carbon is treated with nitric acid.

10. The method of claim 9 wherein the nitric acid is added in an amount of 0.5 to 10 wt % in relation to the pyrolyzed carbon, or 0.5 to 5 wt % or 1 to 3 wt % as compared to the pyrolyzed carbon.

11. The method of claim 9 wherein the pyrolyzed carbon that has been treated with nitric acid is separated and washed with water and, optionally, washed with acetone.

12. The method of claim 1 wherein the step of reacting the pyrolyzed porous carbon with acid is conducted at a temperature of at least 70° C., at least 80° C., or in the range of 80 to 105° C.

13. The method of claim 9 wherein the pyrolyzed carbon that has been treated with acid is treated with a metal-containing solution.

14. The method of claim 13 wherein the metal-containing solution comprises an aqueous Mg solution.

15. The method of claim 13 wherein moles of metal atoms in the metal-containing solution exceeds the moles of COOH moieties.

16. The method of claim 1 wherein the pyrolyzed porous carbon with carboxylic acid moieties that has been contacted with the metal source is subsequently heated to at least 150° C. or heated in the range of 200 to 500° C. or in the range of 300 to 400° C.

17. A sorbent made by the method of claim 1.

18. A sorbent, comprising:
a pyrolyzed porous carbon support;
magnesium and carboxylate moieties disposed in the pyrolyzed porous carbon support; and
characterizable by (possessing):
a CO₂ adsorption isotherm between 0.0 and 0.05 bar CO₂ having a slope that is at least 20% greater than between 0.40 and 0.45 bar CO₂; or
a CO₂ adsorption isotherm between 0.0 and 0.1 bar CO₂ having a slope that is at least 20% greater than between 0.40 and 0.50 bar CO₂.

19. The sorbent of claim 18 characterizable by:
a CO₂ adsorption isotherm between 0.0 and 0.05 bar CO₂ having a slope that is at least 40% greater than between 0.40 and 0.45 bar CO₂.

20. The sorbent of claim 18 characterizable by:
a CO₂ adsorption isotherm between 0.0 and 0.1 bar CO₂ having a slope that is at least 40% greater than between 0.40 and 0.50 bar CO₂.

21. The sorbent of claim 18 characterizable by an infrared absorption peak centered at about 1600 cm⁻¹ having an integrated intensity at least 20 times than the hydroxyl peak at about 1710 cm⁻¹.

22. The sorbent of claim 18 characterizable by an infrared absorption peak centered at about 1600 cm⁻¹ having an integrated intensity at least 20 times than the hydroxyl peak at about 1710 cm⁻¹.

23. A method of removing CO₂ comprising contacting the sorbent with a CO₂-comprising fluid.

24. The method of claim 22 wherein the sorbent maintains at least 95% of its CO₂ sorption capacity after 5 cycles of pressure and/or temperature swing desorption.
